(19) United States
(12) Patent Application Publication
(10) Pub. No.: US 2008/0160147 A1
(43) Pub. Date: Jul. 3, 2008

(54) Method for marketing food and beverages

(76) Inventor: Peter J. Tormey, Concord, CA (US)

Correspondence Address: PETER JAMES TORMEY, 2017 ESPERANZA DRIVE, CONCORD, CA, 94519, US

(21) Appl. No.: 11/649,048

(22) Filed: Jan. 3, 2007

(51) Int. Cl. A23L 1/48

(52) U.S. Cl. 426/383

(57) ABSTRACT

A method for merchandising a food or beverage comprising the following: creating a similarity rating for the food or beverage; associating an indicia representing the similarity rating with the food or beverage; associating the indicia with a promotional material for the food or beverage, and displaying the promotional material to one or more consumers.

### BACKGROUND

The present invention relates generally to a system and method for marketing, and in particular to a system and method for marketing food and beverages.

Faced with competing messages from manufacturers, experts and word-of-mouth references, wine consumers face a difficult task of selecting wines or other gourmet foods. For example, consumers can opt for one of hundreds of different chardonnays from all over the world. The large number of chardonnays from which to choose can make selection especially difficult for novice wine buyers. In one well-known store over 140 chardonnays are carried. Wine buyers must choose which flavor they recall or which brand they think will go best with their event. Consumers, left to guess about wine flavors and qualities, face a difficult task.

To ease their angst when purchasing wines, frequent wine consumers have developed methods employing hand-held computers to track their preferred wines. Tasting clubs may provide tracking information as well. They refer to a database or printed list of recommendations while shopping to see if a wine is one they've had before and would like to purchase again.

The wine publishing industry produces ratings and guides which retailers place on store shelves to guide consumers. Consumers find these guides have several drawbacks. Descriptions and evaluations of wines are wildly subjective; ratings from multiple experts for a given wine may range from “excellent” to “poor” depending on the criteria and personal preferences of each reviewer. Even among well-rated chardonnays there is still a wide variation in taste. Simply buying a well-rated wine will not assure consumer satisfaction.

Quality wine retailers provide expert sales people to assist customers. These retailers rely on a customer's preferences in making their recommendations. For example, if you ask a wine merchant to recommend a wine, the merchant will often ask which wines you like and recommend ones that taste similar. Thus wine sellers know many wines are similar and use this knowledge to guide consumers into purchasing wines they are likely to enjoy.

The wine industry also knows which flavors are the most popular. For example, chardonnay flavors can be grouped into three main areas described as “big melon”, “big grapefruit” and “big earth”. These correspond to sweeter fruit flavored wines, tart citrus flavored wines and tannin or tea flavored wines respectively. Thus the wine industry tracks popular flavors and produces wines to that taste. Often lower quality manufacturers try to simulate the flavors and packaging of the more successful wines because they realize that inferior wines with similar flavors can be marketed to cost conscious consumers at a lower price.

What is needed is a system and method for guiding consumers to food and beverage products based on each consumer's preferences to increase consumer satisfaction and maximize sales.

### SUMMARY

Disclosed is a method for merchandising a food or beverage comprising the following: creating a similarity rating for the food or beverage; associating an indicia representing the similarity rating with the food or beverage; associating the indicia with a promotional material for the food or beverage, and displaying the promotional material to one or more consumers.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates one embodiment of the current invention.

FIG. 2 represents another embodiment of the current invention using wine taste surveys.

FIG. 3 shows yet another embodiment of the current invention using purchasing history to create the similarity rating.

FIG. 4 shows one embodiment of indicia which can indicate the similarity rating of a wine.

FIG. 5 shows one means to create a similarity rating for wines.

FIG. 6 represents a sample of purchasing frequency for four buyers A through D for a selection of eight wines.

FIG. 7 shows a portion of one possible set of icons.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

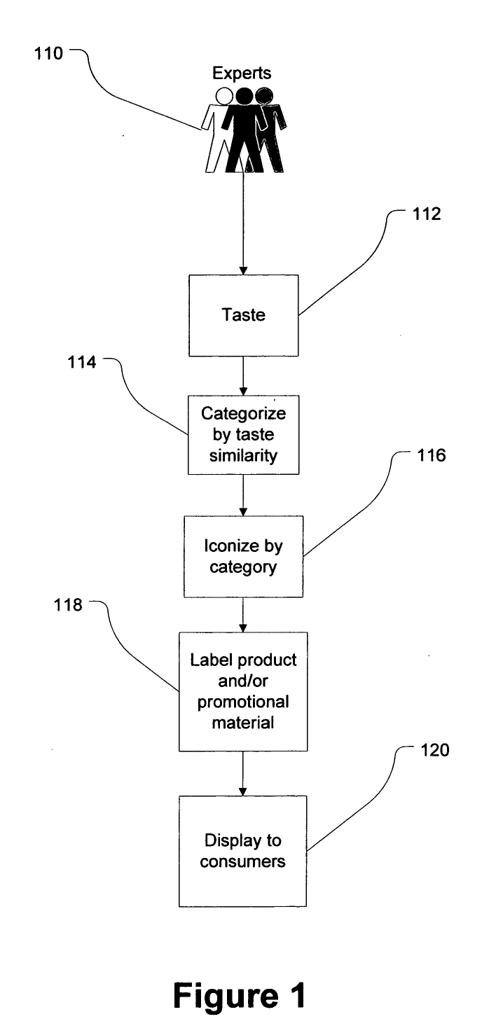

FIG. 1 illustrates one embodiment of the current invention. In FIG. 1 one or more experts 110 are used to taste food and beverage products such as wine, juice, beer or cheese. For the examples in this embodiment wine will be used. The experts are people familiar with the tasting and rating process. The experts may be trained enologists, or taste experts, but it would be in the spirit of this invention to use any people trained to rate wines according to the requirements of the current invention. According to this embodiment of the current invention, rating the wine is to categorize 114 by taste similarity. The taste “similarity rating” is a measure of how alike a group of foods or beverages is. For example, if a similarity rating were developed for wines, two otherwise unrelated wines would be rated as similar so that, if a person liked the taste of the first wine, that person will tend also to like the taste of the second wine of the pair. A similarity rating would allow consumers to know that one wine is likely to taste similar to another before they make their selection. This rating would quantify wine flavors but not wine quality. In keeping with this wine example, the similarity rating may account for the predominate flavor of the wine and also for other characteristics such as relative sweetness.

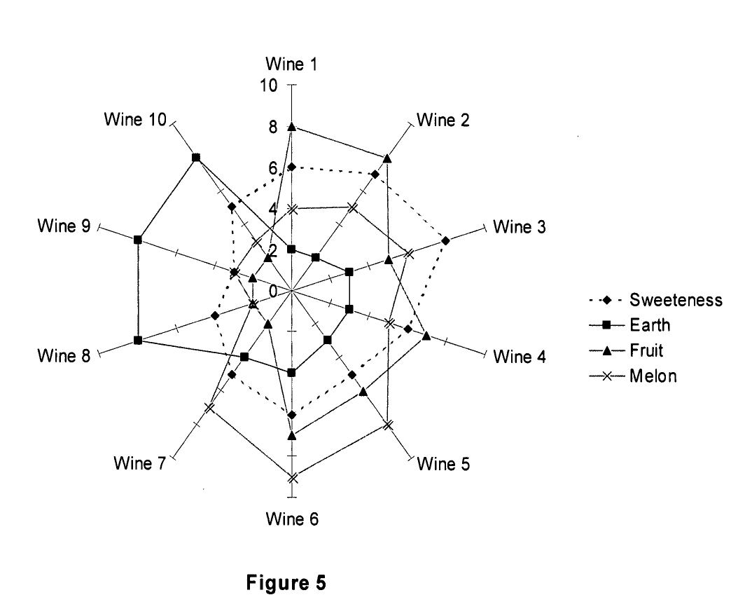

FIG. 5 shows one means to create a similarity rating for wines. Although FIG. 5 shows an example using wine, the current invention can be practiced with other beverages and foods. In FIG. 5 ten wines were rated by experts. These experts were asked to rate the wines by overall sweetness and then to place the wine into one of three flavor categories, “melon”, “earth” or “fruit”. By creating a chart which plots these three flavor categories against relative sweetness, this small sample of wines can be shown to fall into distinctive groups.

The most pronounced group is wines 8, 9 and 10. These wines, according to the experts, share similar earthy flavors and are relatively less sweet than the other wines. These wines would be rated as similar, earthy, dry wines. Another group consists of wines 2, 4, 5 and 6. These wines are relatively sweet and are characterized by the experts as fruity. In this embodiment, the similarity rating is the category by which the wines are grouped. Wines 8, 9 and 10 would have the same similarity rating, and wines 2, 4, 5 and 6 would have a different similarity rating.

Those skilled in the art would readily understand that not every wine will fit into a similarity group. Also it would be in the spirit of the current invention to have flavor categories in addition to the ones described. For example, a larger number of flavor categories may provide a more acceptable similarity rating. Similarly, sweetness may not be a characteristic required to create a similarity rating.

Returning to FIG. 1 and continuing with the wine example, once the wine is categorized a suitable icon is associated 116 with the wine. The icon is any indicia or indicium that conveys the similarity rating (category) of the wine. Once an icon is designated to represent the similarity rating, the icon can be incorporated in product marketing materials. In keeping with the wine example, the icon may be placed on the wine bottle 118. It may also be placed on store shelf tags, packaging, company web sites and other promotional material. Displaying the icon 120 would provide consumers the information necessary to help them make their buying decisions.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

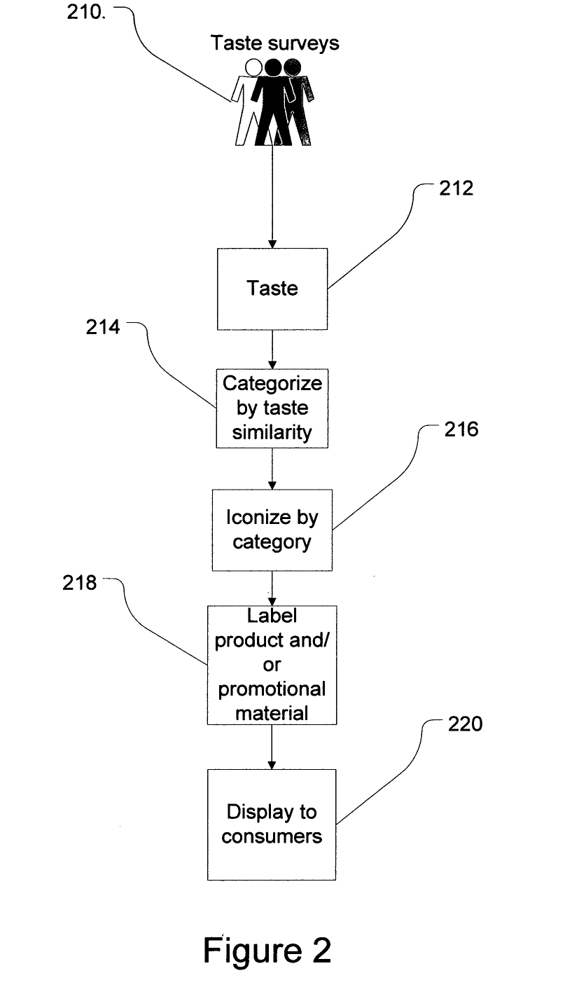

FIG. 2 represents another embodiment of the current invention using wine taste surveys. The taste surveys are performed on consumers who are not trained as wine tasters. The taste surveys provide a similarity rating by providing for a large sample of wine drinkers to classify a wine by its flavor. One way to practice this embodiment is to allow the tasters to taste a wine and rate how well they like it. With a sufficient sample size, groups will appear in the data such that commonalities can be determined. For example, people who prefer sweeter, fruitier wines will show a preference different from that of people who prefer drier, earthier wines. Another way to determine a similarity rating from taste surveys is to ask drinkers to select one of several major taste categories such as fruit, melon or earth. Then ask them to rate the relative sweetness of the wine. These taste impressions will also fall into categories; however a larger sample may be needed to establish reliable data.

In view of the foregoing the wine is tasted 212 and categorized 214 according to similarity. Once the category is established, the icon for the category is associated with the wine 216 and the promotional material for the wine is labeled with the icon 218. Finally the icon is displayed to consumers 220 to aid them in selecting the wine.

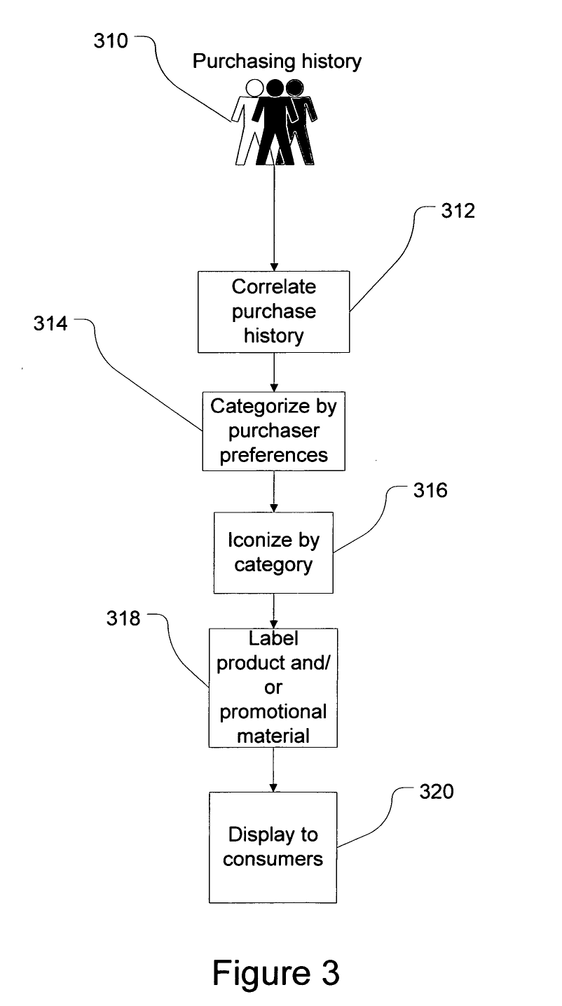

FIG. 3 shows yet another embodiment of the current invention using purchasing history to create the similarity rating. Here, purchasing history is used to develop the similarity rating. People tend to purchase wines they enjoy more than wines they don't enjoy. Their purchasing history 310, over a relatively short term, will indicate their taste preference. The wines are then categorized by purchaser preferences 312 and associated with an icon for the category 316. The icon can then be used on promotional material 318 and displayed to consumers 320.

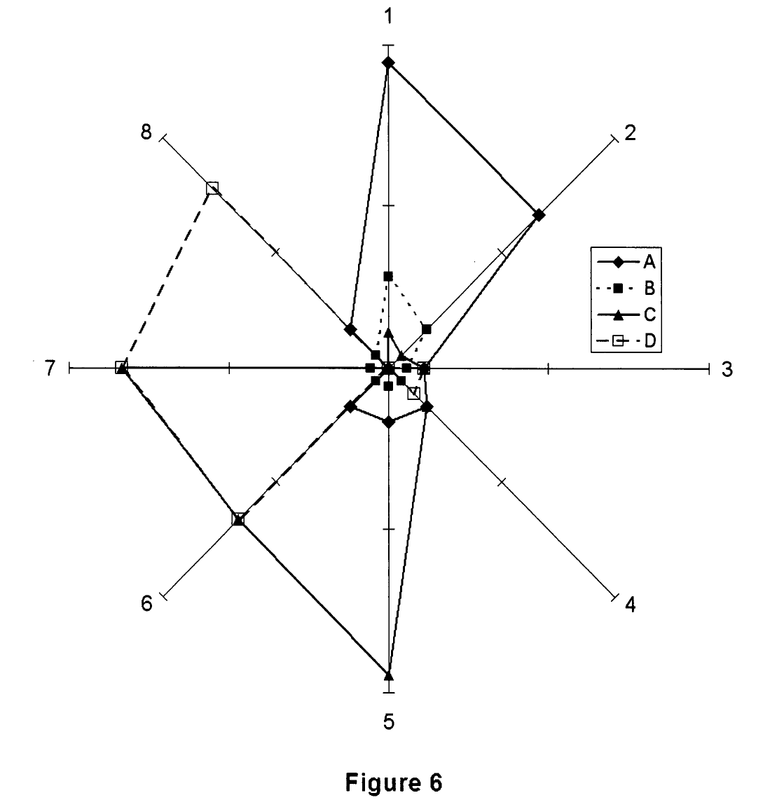

FIG. 6 represents a sample of purchasing frequency for four buyers A through D for a selection of eight wines. In FIG. 6 buyer C and buyer D both purchased wine #6 and wine #7 the same number of times. Buyer C bought wine #5 as many times, but buyer D did not purchase wine #5. Buyer D purchased a quantity of wine #8, but buyer C did not. These data indicate that wines 5, 6, 7 and 8 would constitute entries into a single similarity rating value because buyer C and buyer D prefer many wines in common. FIG. 6 shows a particularly valuable capability of the current invention. The data indicate that buyer D would also enjoy wine #5 even though the buyer D has not purchased it before. Also buyer C would enjoy wine #8 even though buyer C has not purchased it before. This indicates that if a similarity rating were available for both buyers C and D, they might be more likely to purchase a wine they have never purchased before. FIG. 6 also indicates that the buyer B may enjoy wines similar to the wines purchased by buyer A because their purchasing patterns are alike for wines #1 and #2.

Although three different means of generating a similarity rating are presented in this paper, it would be in the spirit of this invention to use additional sources of data such as consumer surveys. It is noted that flavor preferences have regional characteristics based on demographic considerations and that these preferences may need to be accounted for when creating the similarity indices.

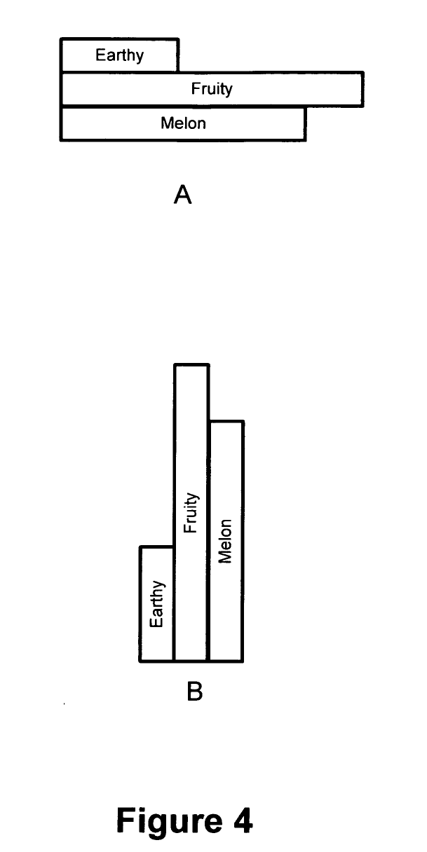

FIG. 4 shows one embodiment of indicia which can indicate the similarity rating of a wine. Here, item A displays a relative scale of the flavors selected for characterization and item B displays a more graphical representation of a comparable similarity rating. It would be in the spirit of this invention to utilize it by creating and employing icons that would appeal to consumers and facilitate wine sales. For example, more stylized icons could be employed, or other electronic representations could be used such as images or names of fictional characters or people. The people represented on an icon would each represent a specific similarity rating. This might allow consumers to identify a face or character with a similarity rating.

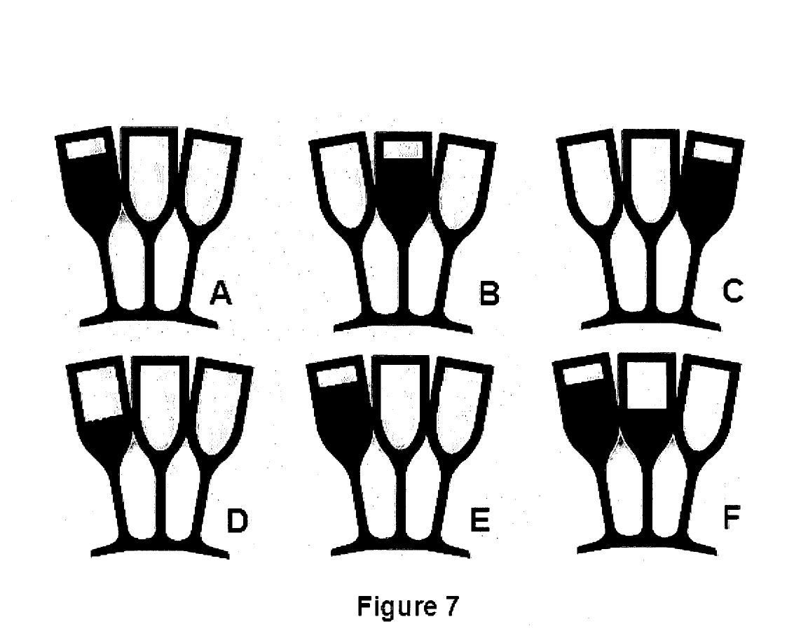

FIG. 7 shows a portion of one possible set of icons. The icons can be arranged to convey a relative scale or a relationship between the different flavor categories. For example, the icon A would indicate an earthy wine, the icon B might indicate a fruity wine and the icon C might indicate a melon flavored wine. The icons A and D are examples of two icons that can convey other relative characteristics. In this example icon A may indicate a sweet earthy wine, whereas icon D may indicate a relatively drier earthy wine. Colors may also be used as icons. For example, a white wine may be characterized by different shades of yellow that would indicate a common taste category. Creating icons which are readily recognized by consumers and which convey a sense of the flavor of the food or beverage with which the icon is associated is consistent with the spirit of this invention.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for merchandising a beverage comprising the following:
creating a similarity rating for the beverage;
associating an indicia representing the similarity rating with the beverage;
associating the indicia with one or more promotional materials for the beverage, and
displaying the promotional material to one or more consumers.

2. The method of claim 1 wherein creating the similarity rating comprises having trained tasters categorize the beverage by flavor.

3. The method of claim 1 wherein creating the similarity rating comprises conducting taste surveys wherein untrained tasters categorize the beverage by flavor.

4. The method of claim 1 wherein creating the similarity rating comprises correlating purchase history data among consumers such that flavor categories are determined.

5. The method of claim 1 wherein the beverage is wine.

6. The method of claim 1 wherein the indicia represents a fictional character.

7. The method of claim 1 wherein the promotional material is selected from a group consisting of shelf labels, product labels, packaging labels or advertisements.

8. The method of claim 1 wherein the beverage is beer.

9. The method of claim 1 wherein the beverage is comprised of fruit juice.

10. A method for merchandising a food comprising the following:
creating a similarity rating for the food;
associating an indicia representing the similarity rating with the food;
associating the indicia with one or more promotional materials for the food, and
displaying the promotional material to one or more consumers.

11. The method of claim 10 wherein creating the similarity rating comprises having trained tasters categorize the food by flavor.

12. The method of claim 10 wherein creating the similarity rating comprises conducting taste surveys wherein untrained tasters categorize the food by flavor.

13. The method of claim 10 wherein creating the similarity rating comprises correlating purchase history data among consumers such that flavor categories are determined.

14. The method of claim 10 wherein the food is cheese.

15. The method of claim 10 wherein the indicia represents a fictional character.

16. The method of claim 10 wherein the promotional material is selected from a group consisting of shelf labels, product labels, packaging labels or advertisements.
